(19) United States
(12) Patent Application Publication
(10) Pub. No.: US 2012/0329590 A1
(43) Pub. Date: Dec. 27, 2012

(54) HYDRAULIC TENSIONER

(75) Inventors: Kazuhiro Yoshii, Osaka (JP); Osamu Yoshida, Osaka (JP)

(73) Assignee: TSUBAKIMOTO CHAIN CO., Osaka (JP)

(21) Appl. No.: 13/526,578

(22) Filed: Jun. 19, 2012

(30) Foreign Application Priority Data
Jun. 23, 2011 (JP) 2011-139855

(51) Int. Cl. F16H 7/08

(52) U.S. Cl. 474/110

(57) ABSTRACT

In a hydraulic tensioner, the seating surface of a ball-type check valve, used to allow oil to enter the oil chamber of the tensioner while blocking reverse flow of oil, is formed with one or more grooves that allow leakage of oil from the oil chamber to an oil supply passage even when the ball is seated. The groove or grooves can have a decreasing depth or decreasing width, proceeding from the opening of the oil passage of the ball seat toward the oil chamber. Plural grooves can be provided at equal circumferential intervals, and the grooves can be circumferentially inclined. In each case, the groove or grooves improve separation of the ball from the seat, and thereby improve responsiveness of the tensioner to variations in chain tension.

### CROSS REFERENCE TO RELATED APPLICATIONS

This application claims priority on the basis of Japanese patent application No. 2011-139855, filed on Jun. 23, 2011 The disclosure of Japanese patent application 2011-139855 is here incorporated by reference.

### FIELD OF THE INVENTION

The invention relates to a hydraulic tensioner for applying tension to a chain such as an engine timing chain, and specifically to a check valve in a hydraulic tensioner.

### BACKGROUND OF THE INVENTION

In a known hydraulic tensioner, described in U.S. Pat. No. 6,203,461, granted on Mar. 20, 2001, oil is introduced into a high pressure oil chamber formed by a plunger and a plunger-receiving hole in a tensioner housing through a check valve having a check ball and a seat. Movement of the check ball toward and away from the seat opens and closes the check valve, depending on the relationship between the pressure of oil in an oil supply passage and the pressure of oil within the oil chamber.

The surface of the seat that is engaged by the check ball can wear over time as a result of repeated seating and separation of the check ball from the seating surface. As a result of deterioration of the seat due to wear, the check ball can become attached to the surface of the seat so that when tension in the chain drops, opening of check valve can be delayed, and flow of oil from the oil supply passage to the oil chamber is delayed, especially when the hydraulic pressure in the oil supply passage exceeds the hydraulic pressure in the oil chamber of the tensioner chamber by only a small amount. For instance, this phenomenon can occur when the oil supply pressure is relatively low during starting of the engine or while the engine is idling. The temporary delay in the build-up of pressure in the oil chamber causes a delay in the application of tension to the chain, and results in the generation of flapping noises by the chain.

A hydraulic tensioner is designed to allow a small amount of leakage of oil from the oil chamber so that the plunger can be set back when chain tension increases, thereby preventing the chain from being under excessive tension. On the other hand, to prevent the flapping noises from occurring, it is desirable to reduce leakage through the check valve as much as possible.

Accordingly, there is a need for a hydraulic tensioner in which attachment of the check ball to the seat is avoided, in which the check valve opens rapidly in response to a pressure difference across the check valve, and in which chain flapping noises are reduced.

There is also a need for a hydraulic tensioner that is capable of reducing the quantity of oil that leaks from the oil chamber to the oil supply passage when the check valve is in the closed condition, a need for improvement of the ability of the tensioner to suppress set back movement of the plunger when a force is applied to the plunger by tension in the chain.

### SUMMARY OF THE INVENTION

The hydraulic tensioner according to the invention comprises a housing having a plunger-accommodating hole and a hollow plunger extending into and protruding from the plunger-accommodating hole. The plunger is movable in the plunger-accommodating hole for maintaining tension in a traveling transmission chain. The plunger and the housing cooperate to form an oil chamber. An oil supply passage is provided in the housing for flow of oil supplied from a source of oil under pressure. The tensioner also comprises a check valve comprising a ball seat, a valve oil passage in the ball seat communicating with the oil supply passage, a seating surface provided an end of the valve oil passage, and a check ball arranged to close and open the valve oil passage respectively by seating on, and separating from, the seating surface.

The seating surface has an abutment portion engageable by the check ball when the ball is seated. The check ball is responsive to the pressure of oil in the oil supply passage and to the pressure of oil in the oil chamber to open the valve oil passage when the pressure in the oil supply passage exceeds the pressure in the oil chamber to allow oil to flow freely from the oil supply passage to the oil chamber, and to close the oil supply passage when the pressure in the oil chamber exceeds the pressure in the oil supply passage. The check valve thereby limits flow of oil from the oil chamber to the oil supply passage.

The seating surface is formed with, and interrupted by, an oil groove having a first end communicating with the valve oil passage and an opposite end communicating with the oil chamber when the check ball closes the valve oil passage. The oil groove provides fluid communication between the valve oil passage and the oil chamber when the check ball closes the valve oil passage. Oil flowing through the oil groove contacts the check ball at a virtual abutment location at which the check ball would contact the seating surface if the seating surface were not interrupted by the oil groove.

In general, when the tension of the chain decreases, the check valve opens, and the plunger advances to apply tension to the chain. When the tension of the chain increases, the check valve closes, and the plunger sets back within an allowable range to prevent excessive tension from being generated in the chain.

Even if the check ball attaches to the seating surface because of wear due to repeated engagement, the area over which the check ball attaches to the seating surface is reduced, and the attachment force is reduced because the seating surface is interrupted by the oil groove.

The hydraulic pressure of the oil flowing through the oil groove and contacting the check ball at the virtual abutment position acts on the check ball in a direction such that it exerts a force tending to separate the check ball from the seating surface. Accordingly, the check ball is prevented from being attached to the seating surface, and the opening of the check valve takes place more reliably.

Because the improved opening of the check valve improves the responsiveness of the plunger in applying tension to the timing chain, it is possible to suppress flapping of the timing chain and to reduce the noise caused by flapping.

Because the oil that leaks from the oil chamber is returned through the oil groove and the valve oil passage to the oil supply passage instead of leaking to the outside of the tensioner, it is possible to prevent excessive tension from being generated in the chain while reducing the consumption of oil supplied from the oil source to the tensioner.

In accordance with a second aspect of the invention, the cross-sectional area of the oil groove decreases, proceeding from the first end to the virtual abutment position. The decrease in the cross-sectional area of the oil groove causes the flow rate of the oil flowing from the valve oil passage to the oil chamber through the oil groove to increase as the oil approaches the virtual abutment position. A resulting increase in friction between the oil flowing from the valve oil passage and the check ball improves the ability of the check valve to open.

In accordance with a third aspect of the invention, the oil groove becomes progressively shallower, proceeding from its first end to the virtual abutment position. Because the oil groove becomes progressively shallower, the flow of oil in the groove has a component in a direction such that a dynamic pressure is exerted on the check ball in the direction urging the check ball away from the seating surface. The dynamic pressure also improves the ability of the check valve to open.

In accordance with a fourth aspect of the invention, the seating surface has at least three oil grooves, each of which has a first end communicating with the valve oil passage and an opposite end communicating with the oil chamber when the check ball closes the valve oil passage. These oil grooves are disposed at uniform circumferential intervals.

The use of plural oil grooves still further improves the ability of the check valve to open, while the uniform circumferential arrangement of the oil grooves on seating surface avoids forces tending to bias the ball in a radial direction, thereby improving the smoothness with which the check valve opens and closes and improving the responsiveness of the tensioner to fluctuations in chain tension.

In accordance with a fifth aspect of the invention, the oil groove, or each of a plurality of uniformly space oil grooves, is inclined in a direction such that its first end is circumferentially offset from its opposite end. In this case, the flow of oil through the groove or grooves exerts a circumferential frictional force tending to rotate the check ball. Accordingly, a still further improvement in the ability of the check valve to open and seat can be realized.

### BRIEF DESCRIPTION OF DRAWINGS

FIG. 1 is a schematic front elevational view of an engine timing drive incorporating a tensioner according to the invention;

FIG. 2A is a longitudinal cross-section of the tensioner;

FIG. 2B is an enlargement of a part of the tensioner within a broken line circle IIB in FIG. 2A;

FIG. 3A is a fragmentary front elevational view of a ball seat of the check valve unit of the tensioner;

FIG. 3B is an enlargement of a part of the ball seat within a broken line circle 111B in FIG. 3A;

FIG. 4A is a section view of the ball seat taken on section plane IVA-IVA in FIG. 3A;

FIG. 4B is an enlargement of a part of the ball seat within a broken line circle IVB in FIG. 4A;

FIG. 4C is an enlarged section view of a part of the ball seat taken on section plane IVC-IVC in FIG. 4B;

FIG. 5A is a sectional view, corresponding to FIG. 4A, of a modified ball seat;

FIG. 5B is an enlargement of a part of the ball seat within a broken line circle VB in FIG. 5A;

FIG. 6A is a sectional view, corresponding to FIG. 3A, of another modified ball seat;

FIG. 6B is an enlargement of a part of the ball seat within a broken line circle VIE in FIG. 6A;

FIG. 7 is a sectional view, corresponding to FIG. 3A, of still another modified ball seat;

FIG. 8A is a sectional view, corresponding to FIG. 3A, of still another modified ball seat; and

FIG. 8B is an enlargement of a part of the ball seat within a broken line circle VIIIB in FIG. 8A;

### PREFERRED EMBODIMENT OF THE INVENTION

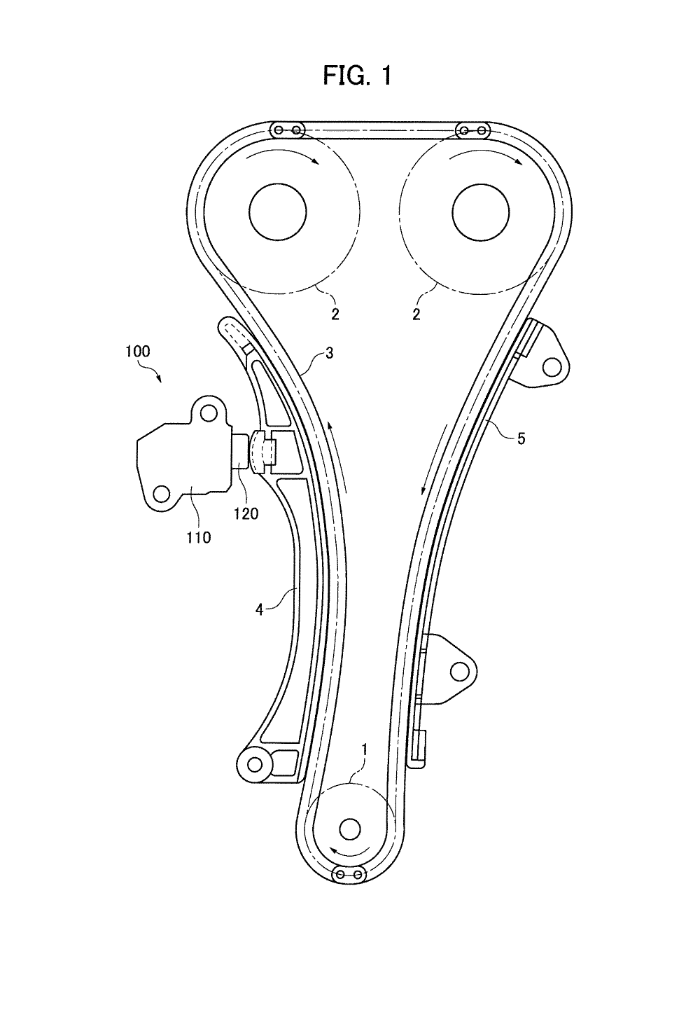

As shown in FIG. 1, the tensioner 100 is mounted on an engine as adjacent the slack side of a timing chain 3. The timing chain 3 is an endless chain driven by the engine crankshaft sprocket 1 and arranged to drive a pair of camshaft sprockets 2.

The tensioner comprises housing 110 and a plunger 120 slidable in, and protruding from, the housing 110. The plunger 120 applies tension to the slack-side of the timing chain 3 through a pivoted lever 4 pressing on the back of the lever at a location remote from the pivot axis. A stationary guide 5 is engaged with the tension side of the timing chain 3. Arrows in FIG. 1 show the direction of movement of the chain and the direction of rotation of the sprockets.

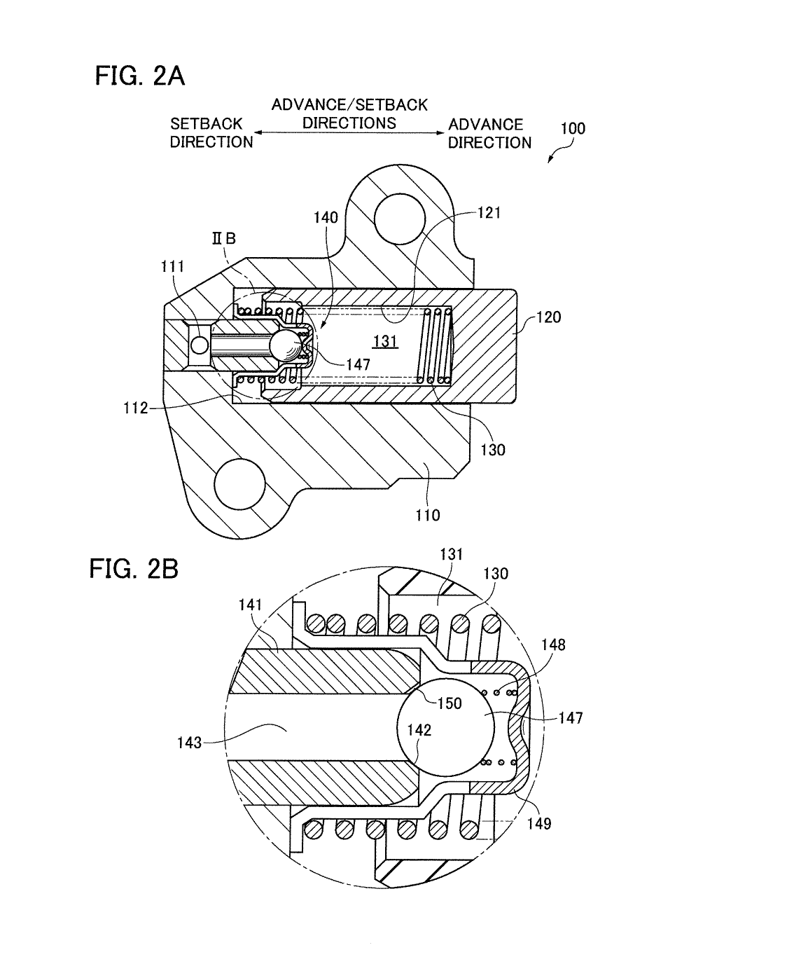

As shown in FIGS. 2A and 2B, the housing 110 is provided with an oil supply passage 111 through which oil is supplied from the engine to a plunger-accommodating hole 112 in the housing 110. A hollow space 121 inside the plunger 120 cooperates with the housing to form an oil chamber 131. A plunger-biasing spring 130 is disposed within the oil chamber 131. The pressure of oil in the oil chamber 131, and the force exerted by the plunger-biasing spring 130, both urge the plunger 120 in the protruding direction. The oil can be supplied to the oil chamber 131 from an oil pump operated by the engine. Therefore the oil pump operates when the engine is running and stops when the engine is stopped.

The check valve unit 140 projects into the oil chamber 131, and comprises a cylindrical ball seat 141 having a valve oil passage 143 communicating with the oil supply passage 111. A seating surface 142 is provided at an end of the ball seat 141, and a spherical check ball 147 is provided to close the valve oil passage 143 by seating on the seating surface 142 and to open the valve oil passage by separating from the seating surface. A check ball-biasing spring 148 presses the check ball against the seating surface 142, and a bell-shaped retainer 149 supports the spring 148 and restricts movement of the check ball 147.

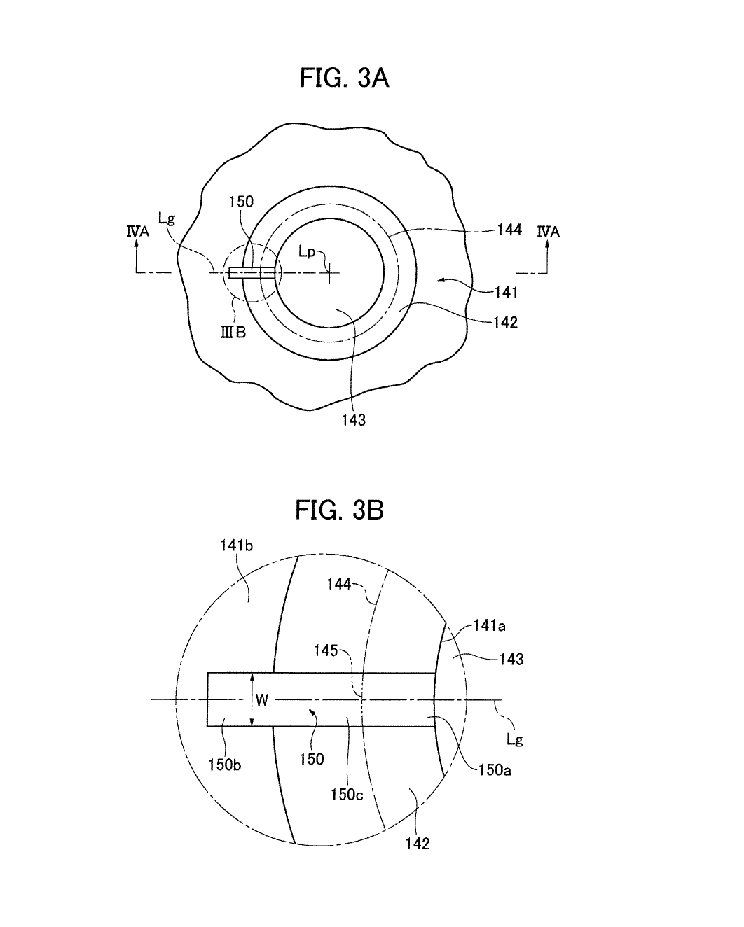

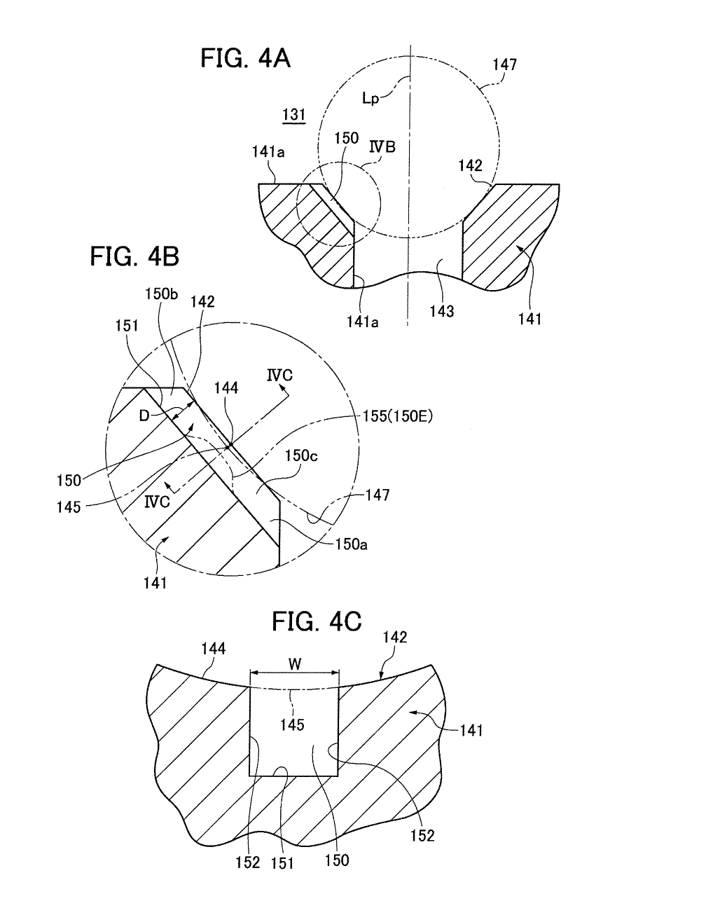

As shown in FIGS. 3A-4C, the seating surface 142 is a generally tapered surface of revolution, symmetrical about an axial line Lp, having its smallest diameter where it meets the valve oil passage 143, and becoming larger proceeding along the axial line in the direction from the oil passage toward the oil chamber of the tensioner. The surface can be frusto-conical, but can deviate from a strict frusto-conical shape. That is, it can be a surface of revolution generated by a curved line instead of by a straight line. The seating surface 142 has an abutment position 144 where the check ball 147 contacts the seating surface. The abutment position is in the shape of a circle or a ring, but is interrupted by an oil groove 150 formed in the seating surface.

The check ball 147 separates from the seating surface 142, opening the check valve and allowing oil to flow into the oil chamber 131, when the pressure of oil in the valve oil passage exceeds the pressure of oil in the oil chamber 131. The ball is pressed against the seating surface, closing the check valve and blocking reverse flow of oil, when the pressure in the oil chamber exceeds the pressure of oil in the valve oil passage.

Even when the check valve is closed, the oil groove 150 provides for restricted fluid communication between the oil chamber 131 and the valve oil passage 143 when the check ball. Thus, while the check ball 147 restricts reverse flow of oil from the oil chamber to the oil passage, the oil groove 150 allows leakage of oil even when the check ball 147 is seated.

The oil groove 150 has a flat bottom surface 151, and a pair of opposed, mutually facing, flat side surfaces 152 spaced from each other by a distance W, which is the width of the groove.

The oil groove 150 is composed of an oil passage side end portion 150a, and an oil chamber-side end portion 150b and an intermediate portion 150c located between end portion 150a and 150b.

In the embodiment shown, the oil passage-side groove end portion 150a opens to a surface 141a of the valve oil passage 143, and the oil chamber-side end portion 150b opens to a radial, oil chamber-side end surface 141b of the ball seat 141. intermediate portion 150c of the groove is open to the seating surface 142.

The oil passage forming surface 141a continues from the narrow end of the tapered seating surface 142, and the oil chamber-side end surface 141b continues from the wide end of the tapered seating surface 142.

As seen in FIG. 3A, the groove 150 is substantially straight, and extends in a direction such that its centerline Lg intersects axial line Lp, i.e., the axis of the valve oil passage 143. Thus groove 150 is not inclined circumferentially, i.e., its projection in a plane to which the axial line Lp is perpendicular extends substantially in a radial direction.

The cross-sectional shape and area of groove 150 is are substantially constant at least along the length of the intermediate portion 150c, i.e., the part of the groove that does not include the end portions 150a and 150b. Accordingly, the depth D of the groove 150 is substantially constant along the length of its intermediate portion 150c. The depth D therefore defines the maximum depth of the groove 150, and can have a value of about 5 μm or more, for example.

The cross-sectional area of the groove is the area of cross-section of the oil groove 150 in a plane to which the line Lg is perpendicular, and bounded by the bottom surface 151, the side surfaces 152 and a virtual seating surface, i.e., an imaginary surface that would have existed if the tapered seating surface 142 were continuous over the region in which the groove is located. The cross-sectional area of the groove, which can be determined by experiments and simulations, is selected so that the setback of the plunger 120, caused by leakage of oil from the oil chamber 131 to the valve oil passage 143 through the oil groove 150, does not exceed an allowable range when the check ball 147 is closed due to an increase in the hydraulic pressure within the oil chamber 131 caused by setting back of the plunger 120 due to an increase in the force exerted by the timing chain on the plunger. The allowable range for setback of the plunger is set in such a way as to suppress flapping of the timing chain that would otherwise occur as a result of excessive setback of the plunger 120.

The part of the virtual seating surface that the check ball 147 virtually abuts can be referred to as a virtual abutment position 145. Oil flowing through the oil groove 150 contacts the check ball 147 at the virtual abutment position 145 and within regions both preceding and following the virtual abutment position 145, along at least a part of the length of the groove.

The shape of the virtual abutment position 145 is either a part of a circle, i.e., an arc, or a part of a ring in a case in which the check ball 147 comes into surface contact with the seating surface 142.

While flow of oil takes place through the oil groove 150, flow of oil is blocked at the abutment position 144 where the check ball 147 abuts the seating surface 142. The abutment position 144 on the seating surface 142 is indicated by a single-dot broken line and the virtual abutment position 145 is indicated by a two-dot broken line in FIGS. 3B and 4C.

Because the abutment position 144 is interrupted by the oil groove 150, the length of the abutment position 144 is short of a complete circle by the width of the virtual abutment position 145. The circumferential length of the abutment position 144 will be referred to as the circumferential length Ca, and the circumferential width will be referred to as the circumferential width Cb. The circumferential width Cb is the circumferential width of the oil groove 150 at the virtual abutment position 145. The circumferential width Cb is equivalent to the length of the arc of the virtual abutment position, which is longer than the groove width W.

Even though wear due to repeated abutment of the check ball with, and separation of the check ball from, the seating surface, would ordinarily cause the check ball to become attached to the seating surface, it is possible to avoid attachment of the check ball to the seating surface because the attachment area is reduced and the attachment force acting on the check ball is correspondingly reduced because the circumferential length Ca of the abutment position 144 is shortened by the circumferential width Cb of the oil groove.

Because the hydraulic pressure, exerted on the check ball at the virtual abutment position 145 by the oil flowing through the oil groove 150, acts in a direction that causes the check ball to separate from the seating surface 142, the ability of the check valve to open is improved. Because the attachment force is reduced, when the hydraulic pressure in the oil passage 143 exceeds the hydraulic pressure in the oil chamber 131, the check ball 147 readily separates from the seating surface 142 and the check valve opens. When the oil passage 143 is opened and the oil in the oil supply passage 111 flows into the oil chamber 131 through the valve oil passage 143, the plunger 120, biased by the plunger-biasing spring 130 and by the oil in the oil chamber 131, advances and applies tension to the timing chain through the pivoted lever. Thus, when the tension in the timing chain is reduced, the tensioner 100 rapidly restores tension by opening the check ball 147 and advancing the plunger 120.

When the tension of the timing chain increases due to fluctuations of tension, the hydraulic pressure in the oil chamber 131 rises because the plunger 120 is pressed in the setback direction against the biasing force of the plunger-biasing spring 130 and the pressure of the oil of the oil chamber 131. When the plunger is moved in the setback direction, the check ball 147 seats on the seating surface 142 and closes the valve because the hydraulic pressure in the oil chamber 131 exceeds the hydraulic pressure in the valve oil passage.

Leakage of oil through the oil groove 150 to the valve oil passage 143 allows the plunger to set back when excessive tension in the chain urges the plunger in the setback direction, so that the excessive tension in the chain is relieved. However, leakage of the oil through the oil groove to the oil passage 143 is limited, and the pressure of the oil in the oil chamber therefore limits setback of the plunger 120 to an allowable range. Thus, it is possible to prevent the plunger 120 from setting back excessively, and thereby prevent the tension in the timing chain from dropping excessively.

Even if the seating surface 142 wears in such a way as to fit the check ball 147 so well that attachment of the check ball to seating surface occurs, the oil groove in the seating surface interrupts and reduces the attachment area. Moreover, the hydraulic pressure of the oil flowing through the oil groove and contacting the check ball at the virtual abutment position acts on the check ball in a direction causing the check ball to separate from the seating surface. Accordingly, it is possible to prevent the check ball from attaching to the seating surface and to improve the ability of the check valve to open. Because the check valve opens more reliably, the responsiveness of the plunger in applying tension to the timing chain improves, and it is possible to suppress flapping of the timing chain and to reduce the noise caused by the flapping.

Furthermore, because the oil leaking from the oil chamber is returned by the oil groove to the oil supply passage instead of being allowed to leak to the outside of the tensioner, it is possible to reduce the consumption of oil.

In the modifications described below, components corresponding to components already described are denoted by the same reference numerals. In each of the following modifications, the cross-sectional area of the oil groove or the total cross-section of plural oil grooves is set so that the setback of the plunger does not exceed a predetermined allowable range.

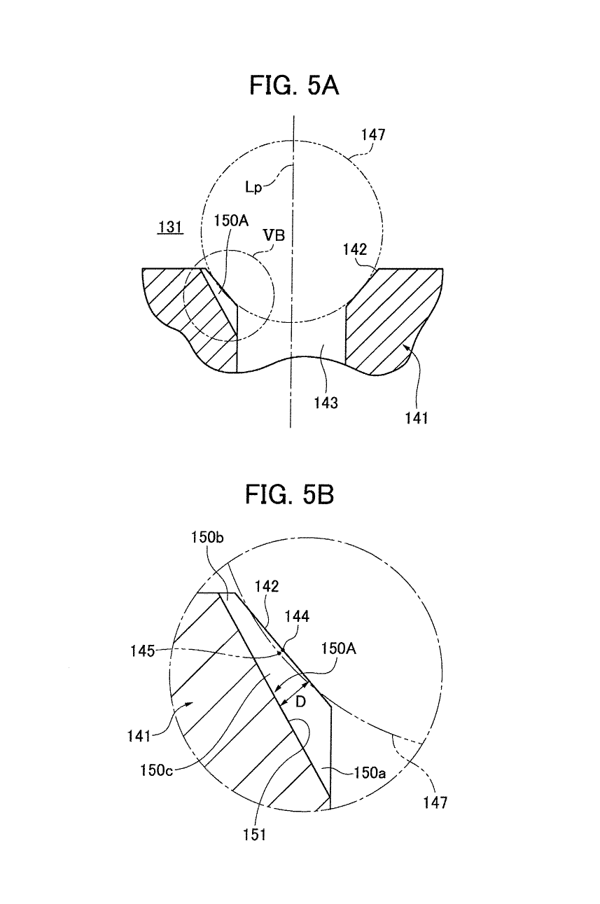

As shown in FIGS. 5A and 5B, the groove depth D varies along the length of and oil groove 150A. The shape of the groove bottom surface 151 is such that the depth D of the groove decreases continuously at a constant rate along the length of the bottom of the groove throughout the intermediate portion 150c, so that the groove becomes shallower proceeding from the inner end portion 150a at the location of the oil passage to the outer end portion 150b in the oil chamber. Because the depth of groove 150A decreases at a constant rate, the cross-sectional area of the groove also decreases continuously. Therefore, the depth D decreases continuously and the cross-sectional area of the groove decreases continuously at least from the valve oil passage 143 to the virtual abutment position 145

Because the cross-sectional area of the oil groove 150A decreases, the flow rate of the oil flowing from the valve oil passage 143 to the oil chamber 131 through the oil groove 150A in the vicinity of the virtual abutment position is greater than the flow rate of the oil in the region on the side of the valve oil passage on the upstream side of the virtual abutment position. The increased flow rate contributes to an increase in the frictional force between the fluid and the check ball and improves the ability of the check ball to open. Furthermore, because the groove becomes shallower proceeding from the valve oil passage toward the oil chamber, the flow in the vicinity of the virtual abutment position has a component in a direction such that it exerts a dynamic pressure urging the check ball away from the seating surface, further improving the ability of the check valve to open.

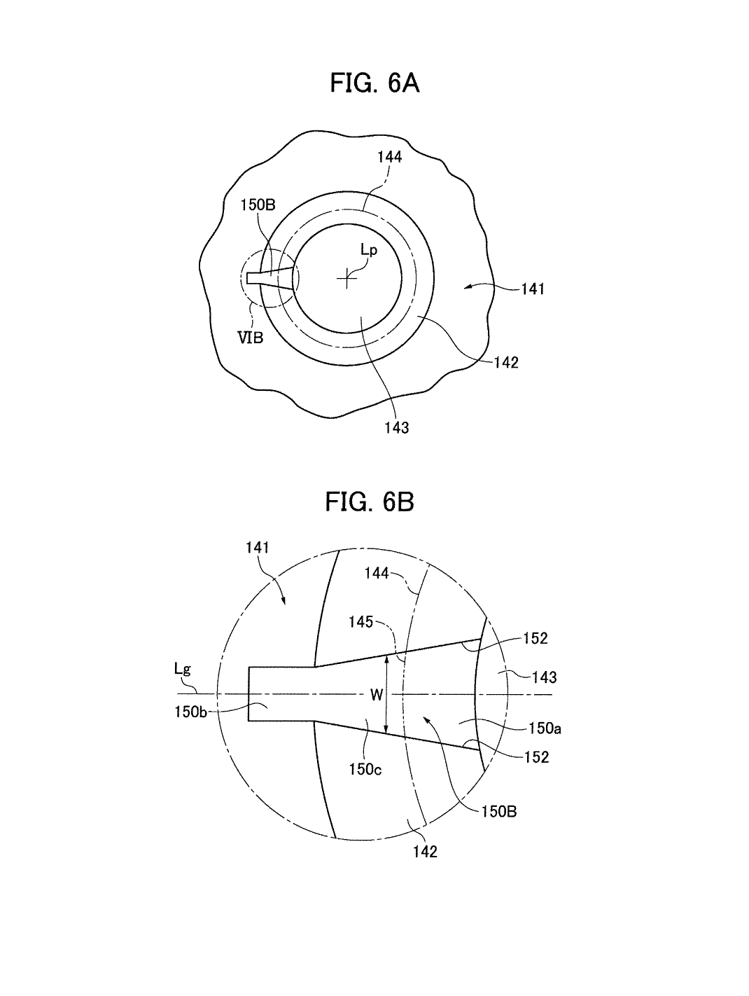

In the modification shown in FIGS. 6A and 6B the width W of oil groove 150B varies. The side surfaces 152 of the groove are formed so that the groove width W decreases continuously at a constant rate proceeding from valve oil passage-side groove end portion 150a toward the oil chamber-side groove end portion 150b. The cross-sectional area of oil groove 150 decreases continuously, and at the constant rate, proceeding from the oil passage-side groove end portion 150a to the oil chamber-side groove end portion 150. Therefore, the width W and the cross-sectional area of the groove decrease continuously proceeding from the end portion 150a adjacent the valve oil passage 143 to the virtual abutment position 145. Although the side surfaces 152 of the groove are symmetrical about a straight line Lg passing through the axial line Lp, the side walls do not need to be symmetrical about the line Lg.

As in the previously described embodiment in which a groove 150A has a continuously decreasing depth, the flow rate of the oil flowing through the oil groove 150B from the valve oil passage 143 to the oil chamber 131 in the vicinity of the virtual abutment position is greater than the flow rate of the oil in the region on the side of the valve oil passage 143 from the virtual abutment position when the check valve is closed.

The second modified example brings about effects similar to those of the first modification in which the groove depth becomes shallower, especially and improvement in the ability of the check ball to open.

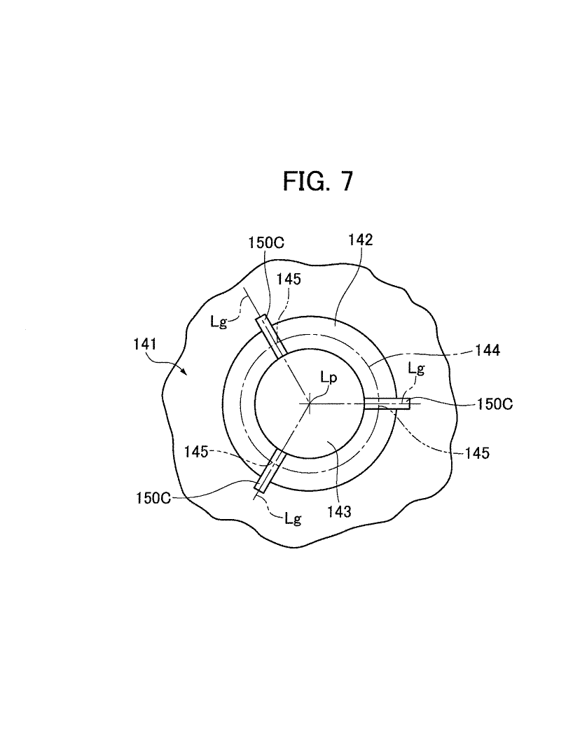

As shown in FIG. 7, the seating surface 142 is provided with three oil grooves 150C. Each oil groove 150C is the same as oil groove 150 in FIGS. 3A-4C, except in the size of their cross sections. For example, the depth D of the grooves in this modification is shallower than that of the oil groove 150 of the embodiment in FIGS. 3A-4C.

The three oil grooves 150C are disposed at uniform intervals in the circumferential direction. Therefore, the abutment position 144 is divided into parts equal in number to the number of oil grooves 150C. The check ball contacting area of the seating surface is reduced accordingly.

Because the hydraulic pressures of the oil flowing through the oil grooves 150C on the seating surface 142, and applied to the check ball 147, are substantially equal, the check ball is prevented from being biased in the radial direction, and remains centered on axial line Lp when the check ball 147 is separated from the seat.

The plural grooves in the modification in FIG. 7 further improve the opening of the check valve. Moreover, the uniform circumferential distribution of the grooves prevents the check ball from being biased in the radial direction. Therefore, it is possible to improve the smoothness of opening the check ball. It also becomes possible to improve the return of the check ball to the ball seat and thereby control the tension of the chain more effectively.

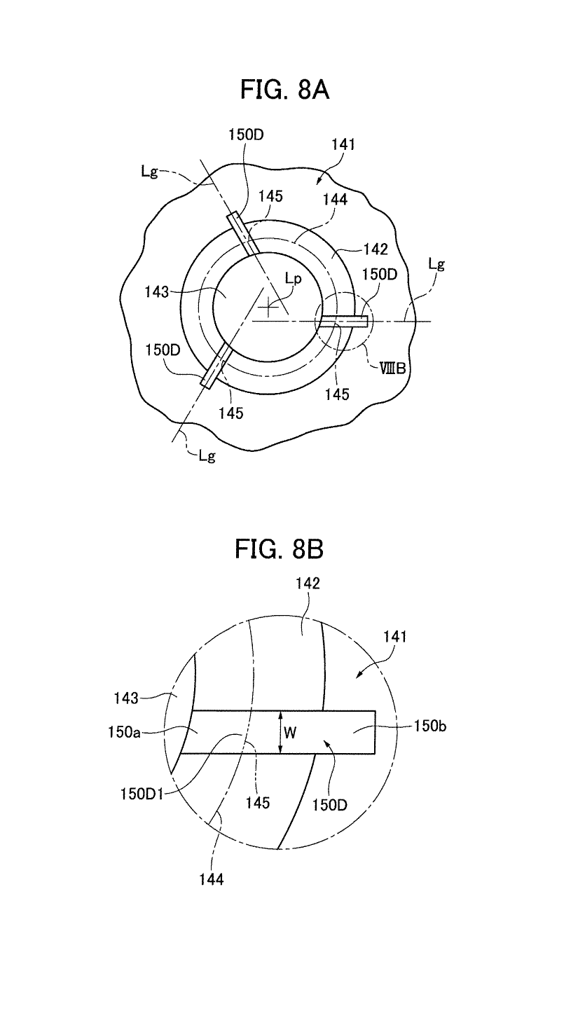

In the modification shown in FIG. 8, three oil grooves 150D are disposed at equal intervals in the circumferential direction. Each oil groove 150D is a groove having a substantially constant cross-sectional area and shape along its intermediate portion, i.e. the portion except of the valve oil passage-side groove end portion 150a and the oil chamber-side groove end portion 150b. The depth D of each groove 150D is shallower than that of the seat oil groove 150 of the embodiment shown in FIGS. 4A-4C.

The oil grooves 150D are inclined in the same direction circumferentially. That is, the outer end of each groove is offset circumferentially form the inner end thereof.

Each of these oil grooves 150D extends substantially parallel to a radial direction so that the center line Lg of each seat oil groove 150D is located substantially on a straight line offset by a predetermined distance from the center axial line Lp.

The frictional force of the oil flowing through the oil grooves 150D tends to rotate the check ball, a shearing force acts in the circumferential direction between the seating surface 142 and the seated check ball, and the check ball rotates about axial line Lp after it is separated from the seating surface 142.

The degree of inclination of each seat oil groove 150D determines the rotational speed of the check ball 147, and is set appropriately to improve the ability of the check valve to open. In general, the rotational speed of the check ball is preferably large.

As shown in FIG. 8, each oil groove 150D has a groove portion 150D1 that corresponds to a virtual abutment position. The abutment position-corresponding groove portion 150D1 extends while inclining in the circumferential direction with respect to the radial direction as the position in the seat oil groove 150D with respect to the virtual abutment position 145 changes from the side of the valve oil passage 143 to the side of the oil chamber 131 through the virtual abutment position 145. Because the grooves are inclined, the circumferential width Cb of the groove at groove portion 150D1 is larger than the groove width W.

With this arrangement, as compared to the circumferential width Cb of the virtual abutment position 145 when the seat oil groove extends only in the radial direction (the circumferential width Cb of the oil groove 150 shown in FIG. 3 for example), the circumferential width Cb of the virtual abutment position 145 is large at the abutment position-corresponding groove portion 150D1. The increase in the circumferential width Cb of the oil groove results in a decrease in the attachment area of the check ball 147 with the seating surface 142.

An inclined groove, and in particular the use of plural inclined grooves as in FIGS. 8A and 8B still further improves the ability of the check ball to open.

The oil grooves 150D are oriented in the same circumferential direction, with the result that the oil flowing from the valve oil passage to the oil chamber through the oil grooves has flow rate component that is directional in one circumferential direction and exerts a circumferential component force of a frictional force on the check ball, tending to rotate the check ball. Accordingly, the check valve more readily separates from the seating surface and the opening of the check valve is improved.

Because the check ball 147 begins to rotate immediately after it is separated from the seating surface 142, the check ball is prevented being biased in the radial direction. The inclined grooves also improve the return of the check ball to its seated position especially in a case in which the check ball that has just separated from the seating surface seats again due to an increase of hydraulic pressure in the oil chamber caused by the setback of the plunger 120.

The circumferential inclination of the grooves also increases he circumferential width of the virtual abutment positions, and thereby further suppresses attachment of the check ball to the seating surface, improving the ability of the check ball to separate from the seating surface and improving the ability of the check valve to open.

Moreover, in the case of a circumferentially inclined groove or plurality of circumferentially inclined grooves, because the circumferential width Cb is larger than the groove width W at the abutment position, it is possible to reduce the groove width W while increasing the circumferential width Cb. Accordingly it is possible to reduce the flow rate of the oil flowing through the oil groove 150D by increasing reducing the groove width W. Therefore, it is possible to improve the plunger setback suppressing effect of the oil of the oil chamber 131 by reducing the quantity of oil leaking through the oil groove or grooves 150D.

Various modifications can be made to the embodiments described above. For example, the groove can be a groove 150E having a bulge 155 indicated by a two-dot chain line in FIG. 4B. The bulge 155 is a local region bulging from the groove bottom surface 151 so that the groove 150E is shallowest in the vicinity of the virtual abutment position 145. The operation and effects are similar to those of the oil groove 150A in FIG. 5.

The shape of the oil groove, including the shape of the transverse cross-section and the shape of the longitudinal cross-section, can have a stepwise change instead of a continuous change, and the rate of change can vary along the length of the groove.

The plurality of oil grooves 150C and 150D in the third and fourth modified examples may be composed of oil grooves that become shallower as in the case of groove 150A in FIGS. 5A and 5B, or grooves that become narrower as in the case of groove 150B in FIGS. 6A and 6B. Alternatively, the grooves can be composed of various combinations of grooves 150, 150A and 150B.

Regarding the third and fourth modified examples, the plurality of seat oil grooves 150C and 150D may be disposed at different intervals in the circumferential direction.

The oil grooves may also be open the seating surface without opening at the oil chamber end or without opening in the valve oil passage forming surface 141a.

In the case of circumferentially inclined oil grooves, the grooves can be inclined in either circumferential direction.

It is also possible to define the shape of the opposed side surfaces of the grooves so that the groove width W increases proceeding from valve oil passage toward the oil chamber. With a check ball having a larger outer diameter, the circumferential width of the virtual abutment position becomes larger. It is therefore possible to achieve favorable results in terms of suppressing the attachment of the check ball to the seating surface even if a check ball having a large outer diameter is used.

The oil groove or grooves can also have a curved or bent-shape.

The ball seat need not be composed of a member distinct from the tensioner housing, and may be composed of a part of the housing itself.

The tensioner can be used not only with a chain, but also with another endless flexible traveling transmission medium such as a belt. In addition, the tensioner may be used to maintain tension in a chain or belt in a machine other than an engine.

What is claimed is:

1. A hydraulic tensioner comprising:
a housing having a plunger-accommodating hole;
a hollow plunger extending into, and protruding from, the plunger-accommodating hole, and movable therein for maintaining tension in a traveling transmission chain, the plunger and the housing cooperating to form an oil chamber;
an oil supply passage provided in the housing for flow of oil supplied from a source of oil under pressure;
a check valve comprising a ball seat, a valve oil passage in the ball seat communicating with the oil supply passage, a seating surface provided an end of the valve oil passage, and a check ball arranged to close and open the valve oil passage respectively by seating on, and separating from, the seating surface;
wherein the seating surface has an abutment position engageable by the check ball when the ball is seated;
wherein the check ball is responsive to the pressure of oil in the oil supply passage and to the pressure of oil in the oil chamber to open the valve oil passage when the pressure in the oil supply passage exceeds the pressure in the oil chamber to allow oil to flow freely from the oil supply passage to the oil chamber, and to close the oil supply passage when the pressure in the oil chamber exceeds the pressure in the oil supply passage, thereby limiting flow of oil from the oil chamber to the oil supply passage;
wherein the seating surface is formed with and interrupted by an oil groove having a first end communicating with the valve oil passage and an opposite end communicating with the oil chamber when the check ball closes the valve oil passage, whereby the oil groove provides fluid communication between the valve oil passage and the oil chamber when the check ball closes the valve oil passage; and
wherein oil flowing through the oil groove contacts the check ball at a virtual abutment location at which the check ball would contact the seating surface if the seating surface were not interrupted by the oil groove.

2. The hydraulic tensioner according to claim 1, wherein the cross-sectional area of the oil groove decreases proceeding from said first end thereof to said virtual abutment position.

3. The hydraulic tensioner according to claim 1, wherein said oil groove becomes progressively shallower proceeding from said first end thereof to said virtual abutment position.

4. The hydraulic tensioner according to claim 1, wherein the seating surface has at least three oil grooves formed therein, each said oil groove having a first end communicating with the valve oil passage and an opposite end communicating with the oil chamber when the check ball closes the valve oil passage, said oil grooves being disposed at uniform circumferential intervals.

5. The hydraulic tensioner according to claim 1, wherein said oil groove is inclined in a direction such that its first end is circumferentially offset from its opposite end.

6. The hydraulic tensioner according to claim 1, wherein the seating surface has at least three oil grooves formed therein, each said oil groove having a first end communicating with the valve oil passage and an opposite end communicating with the oil chamber when the check ball closes the valve oil passage formed therein, said oil grooves being disposed at uniform circumferential intervals, and wherein each of said oil grooves is inclined in a direction such that its first end is circumferentially offset from its opposite end.
